(19) United States
(12) Patent Application Publication
(10) Pub. No.: US 2025/0093522 A1
(43) Pub. Date: Mar. 20, 2025

(54) METHOD FOR RESOLVING A CONFLICT BETWEEN A MEASUREMENT AND A COMMUNICATION OF A TERMINAL DEVICE AND TERMINAL DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN); Zuomin WU, Dongguan (CN); Xinlei YU, Dongguan (CN)

(21) Appl. No.: 18/967,939

(22) Filed: Dec. 4, 2024

Related U.S. Application Data
(63) Continuation of application No. PCT/CN2022/101872, filed on Jun. 28, 2022.

(51) Int. Cl. G01S 19/21; H04W 24/08

(52) U.S. Cl. CPC G01S 19/21; H04W 24/08

(57) ABSTRACT

A method for resolving a conflict between a measurement and a communication of a terminal device includes: determining, by the terminal device, whether to start a second timer according to whether the terminal device is in a GNSS measurement period, in a case where a first timer times out, where the second timer is used by the terminal device to acquire system information within valid time of the second timer.

### CROSS-REFERENCE TO RELATED APPLICATION

This application is a Continuation Application of International Application No. PCT/CN2022/101872 filed on Jun. 28, 2022, which is incorporated herein by reference in its entirety.

### TECHNICAL FIELD

The present disclosure relates to the field of communications, and in particular, to a method for resolving a conflict between a measurement and a communication of a terminal device, and a terminal device.

### BACKGROUND

Currently, IoT (Internet of Things) terminal capabilities have been enhanced in IoT NTN (Non-Terrestrial Network), and UE (User Equipment) may perform a GNSS (Global Navigation Satellite System) position fix operation in an RRC (Radio Resource Control) connected state. Based on the current understanding, the IoT terminal needs to stop a communication module related operation during performing the GNSS position fix operation.

Therefore, if the UE is performing a GNSS measurement at a certain moment, T317 times out. The UE needs to start the T318 timer at that moment simultaneously, to acquire SIB31. If the SIB (System Information Block) 31 is acquired within valid time of the T318 timer, the UE will enter an RLF (Radio Link Failure). Since the UE needs to perform the GNSS position fix operation in the GNSS measurement period, the UE cannot read the SIB31 in the GNSS measurement period. Obviously, in this case, the existing mechanism will shorten the time that the UE may actually read the SIB31, and increase the risk of the RLF occurring in the UE.

In addition, if the UE is in the T318 running period at a certain moment, the UE triggers the GNSS measurement. Since the reading of the SIB31 and the GNSS position fix operation cannot be performed at the same time, it is obvious that the existing mechanism has a problem that needs to be solved, of whether the UE needs to continue to read the SIB31 or perform the GNSS measurement first.

### SUMMARY

Embodiments of the present disclosure provide a method and an apparatus for resolving a conflict between a measurement and a communication of a terminal device.

According to an embodiment of the present disclosure, a method for resolving a conflict between a measurement and a communication of a terminal device is provided, and includes: determining, by the terminal device, whether to start a second timer according to whether the terminal device is in a global navigation satellite system (GNSS) measurement period, in a case where a first timer times out, where the second timer is used by the terminal device to acquire system information within valid time of the second timer.

According to an embodiment of the present disclosure, an apparatus for resolving a conflict between a measurement and a communication of a terminal device is provided, and includes: a first determining module, configured to determine whether to start a second timer according to whether the terminal device is in a global navigation satellite system (GNSS) measurement period, in a case where a first timer times out, where the second timer is used by the terminal device to acquire system information within valid time of the second timer.

According to another embodiment of the present disclosure, a method for resolving a conflict between a measurement and a communication of a terminal device is provided, and includes: determining, by the terminal device, starting time of a second timer and/or a duration of the second timer, in a case where the terminal device starts a GNSS measurement, when a first timer times out, where the second timer is used by the terminal device to acquire system information within valid time of the second timer.

According to another embodiment of the present disclosure, an apparatus for resolving a conflict between a measurement and a communication of a terminal device is provided, located in the terminal device, and includes: a second determining module, configured to determine starting time of a second timer and/or a duration of the second timer, in a case where a GNSS measurement is started, when a first timer times out, where the second timer is used to acquire system information within valid time of the second timer.

### BRIEF DESCRIPTION OF THE DRAWINGS

The drawings described herein are used to provide understanding of the present disclosure and constitute a part of the present disclosure. The schematic embodiments of the present disclosure and descriptions thereof are used to explain the present disclosure and do not constitute improper limitations on the present disclosure. In the drawings:

FIG. 1 is a structural schematic diagram of an NTN network architecture based on transparent forwarding according to the embodiments of the present disclosure;

FIG. 2 is a structural schematic diagram of an NTN network architecture based on regenerative forwarding according to the embodiments of the present disclosure;

FIGS. 3A and 3B are schematic diagrams showing time synchronization at an eNB or gNB side according to the embodiments of the present disclosure;

FIG. 4 is a flow chart of a method for resolving a conflict between a measurement and a communication of a terminal device according to the embodiments of the present disclosure;

FIG. 5 is a structural block diagram of an apparatus for resolving a conflict between a measurement and a communication of a terminal device according to the embodiments of the present disclosure;

FIG. 6 is a timing diagram of a terminal device running based on scenario 1 according to the embodiments of the present disclosure;

FIG. 7 is a timing diagram of a terminal device running based on scenario 2 according to the embodiments of the present disclosure;

FIG. 8 is a flow chart of a method for resolving a conflict between a measurement and a communication of a terminal device according to the embodiments of the present disclosure;

FIG. 9 is a structural block diagram of an apparatus for resolving a conflict between a measurement and a communication of a terminal device according to the embodiments of the present disclosure;

FIG. 10 is a timing diagram of a terminal device running based on scenario 3 according to the embodiments of the present disclosure;

FIG. 11 is a timing diagram of a terminal device running based on scenario 4 according to the embodiments of the present disclosure;

FIG. 12 is a first timing diagram of the starting and valid time of a T318 timer according to the embodiments of the present disclosure;

FIG. 13 is a second timing diagram of the starting and valid time of a T318 timer according to the embodiments of the present disclosure;

FIG. 14 is a third timing diagram of the starting and valid time of a T318 timer according to the embodiments of the present disclosure;

FIG. 15 is a fourth timing diagram of the starting and valid time of a T318 timer according to the embodiments of the present disclosure;

FIG. 16 is a fifth timing diagram of the starting and valid time of a T318 timer according to the embodiments of the present disclosure;

FIG. 17 is a sixth timing diagram of the starting and valid time of a T318 timer according to the embodiments of the present disclosure;

FIG. 18 is a seventh timing diagram of the starting and valid time of a T318 timer according to the embodiments of the present disclosure;

FIG. 19 is an eighth timing diagram of the starting and valid time of a T318 timer according to the embodiments of the present disclosure;

FIG. 20 is a ninth timing diagram of the starting and valid time of a T318 timer according to the embodiments of the present disclosure;

FIG. 21 is a tenth timing diagram of the starting and valid time of a T318 timer according to the embodiments of the present disclosure;

FIG. 22 is a structural schematic diagram of a terminal device according to the embodiments of the present disclosure; and

FIG. 23 is a structural schematic diagram of another terminal device according to the embodiments of the present disclosure.

### DETAILED DESCRIPTION

The present disclosure will be described in detail below with reference to the drawings and in combination with the embodiments. It should be noted that, the embodiments and features in the embodiments of the present disclosure may be combined with each other without a conflict.

It should be noted that the terms “first”, “second”, etc., in the specification and claims and the above-mentioned drawings of the present disclosure are used to distinguish similar objects, and are not necessarily used to describe a specific order or sequence.

The technical solutions of the embodiments of the present disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN), a Wireless Fidelity (WiFi), a fifth-generation communication (5th-Generation, 5G) system, or other communication systems, etc.

Currently, 3GPP (the 3rd Generation Partnership Project) is studying the Non Terrestrial Network (NTN) technology. NTN generally provides communication services to terrestrial users by a satellite communication. Compared with the terrestrial cellular network communication, the satellite communication has many unique advantages. First, the satellite communication is not restricted by the user's geographical location. For example, the general land communication cannot cover oceans, mountains, deserts, and other areas where a communication device cannot be set up or without the communication coverage due to sparse populations. However, for the satellite communication, since a satellite may cover a larger ground and the satellite may move in orbit around the Earth, in theory, every corner on the Earth may be covered by the satellite communication. Second, the satellite communication has great social value. The satellite communication may cover at a relatively low cost in a remote mountainous area, poor and backward countries or regions, thereby allowing people in these regions to enjoy advanced voice communications and mobile Internet technologies, which is conducive to narrowing the digital gap with developed areas and promoting the development of these regions. Third, the satellite communication has a long distance, and the cost of the communication does not increase significantly as the communication distance increases; finally, the satellite communication has high stability and is not restricted by natural disasters.

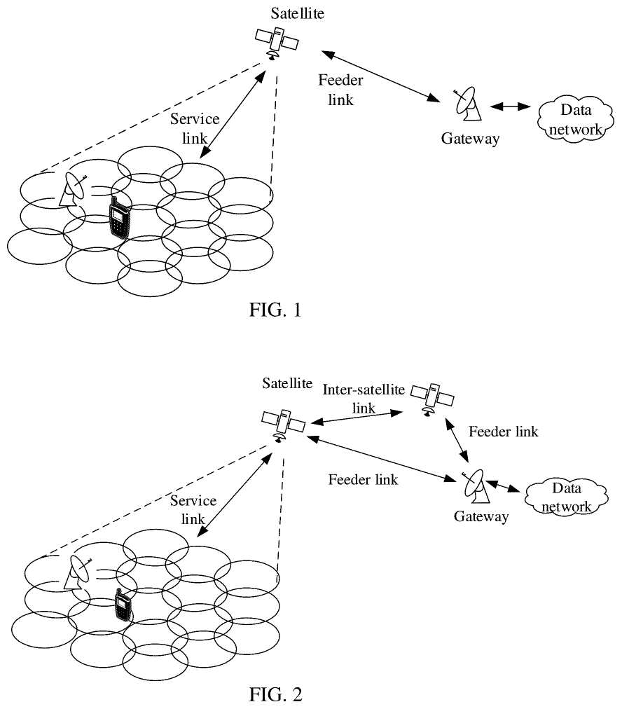

FIG. 1 is a structural schematic diagram of an NTN network architecture based on transparent forwarding according to the embodiments of the present disclosure.

FIG. 2 is a structural schematic diagram of an NTN network architecture based on regenerative forwarding according to the embodiments of the present disclosure.

Communication satellites are divided into a Low-Earth Orbit (LEO) satellite, a Medium-Earth Orbit (MEO) satellite, a Geostationary Earth Orbit (GEO) satellite, a High Elliptical Orbit (HEO) satellite, etc., according to different orbit altitudes. At this stage, the main research is on the LEO and the GEO.

LEO: an altitude of a low-orbit satellite ranges from 500 km to 1500 km, and the corresponding orbit period is approximately 1.5 hours to 2 hours. The signal propagation delay of a single-hop communication between users is generally less than 20 ms. The maximum satellite visibility time is 20 minutes. The signal propagation distance is short, the link loss is small, and the requirement for the transmission power of the user terminal is not high.

GEO: a geostationary earth orbit satellite, has an orbit altitude of 35786 km and a rotation period around the Earth of 24 hours. The signal propagation delay of a single-hop communication between users is generally 250 ms.

In order to ensure the satellite's coverage and improve the system capacity of the entire satellite communication system, the satellite uses multiple beams to cover the ground. A satellite may form tens or even hundreds of beams to cover the ground; a satellite beam may cover a ground area with a diameter of tens to hundreds of kilometers.

The NTN network consists of the following network elements.

One or more gateways, are used to connect the satellite and a terrestrial public network.

Feeder link: a link is used for the communication between the gateway and the satellite.

Service link: a link is used for the communication between the terminal and the satellite.

Satellite: may be divided into transparent forwarding and regenerative forwarding based on functions provided by the satellite.

Transparent forwarding: only provides functions of radio frequency filtering, frequency conversion and amplification, and only provides transparent forwarding of a signal, without changing the waveform signal forwarded by it.

Regenerative forwarding: in addition to providing functions of radio frequency filtering, frequency conversion and amplification, may also provide functions of demodulation/decoding, routing/conversion, and encoding/modulation. It has a part of or all functions of a base station.

Intersatellite link: exists under a regenerative forwarding network architecture.

LTE/NR terrestrial network uplink timing advance.

An important feature of uplink transmissions is orthogonal multiple access of different UEs in time and frequency, that is, uplink transmissions from different UEs in a same cell do not interfere with each other.

To ensure the orthogonality of the uplink transmissions and avoid the intra-cell interference, the eNB/gNB requires that the time when signals from different UEs at the same time but different frequency domain resources arrive at the eNB/gNB is basically aligned. To ensure time synchronization at the eNB/gNB side, LTE/NR supports a mechanism of an uplink timing advance.

An uplink clock and a downlink clock at the eNB/gNB side are the same, while there is an offset between an uplink clock and a downlink clock at the UE side, and different UEs have respective different uplink timing advances. By appropriately controlling an offset of each UE, the eNB/gNB may control the time when uplink signals from different UEs arrive the eNB/gNB. For a UE that is farther away from the eNB/gNB, due to a larger transmission delay, it needs to transmit uplink data earlier than a UE that is closer to the eNB/gNB.

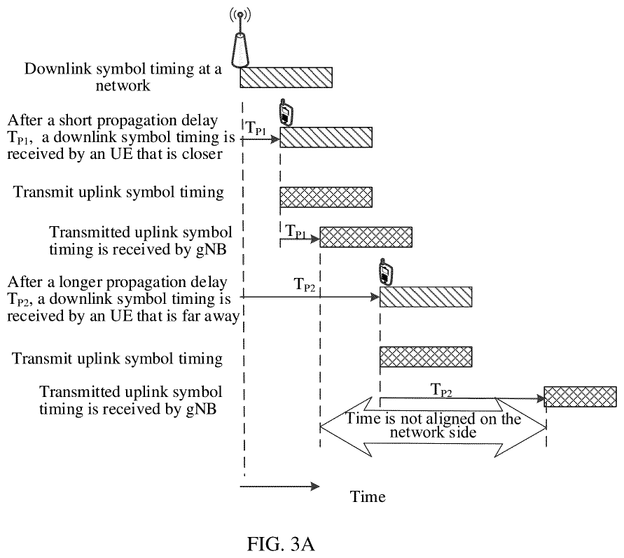

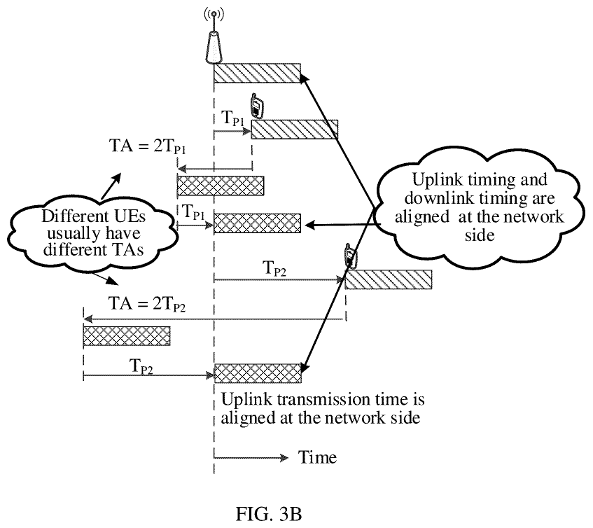

FIGS. 3A and 3B are schematic diagrams showing time synchronization at an eNB or gNB side according to the embodiments of the present disclosure.

As shown in FIGS. 3A and 3B, the eNB/gNB determines a TA value of each UE based on measuring the uplink transmission of the UE. The eNB/gNB transmits a TA command to the UE in two manners.

Acquisition of an initial TA: in a random access process, the eNB/gNB determines a TA value by measuring a received preamble and transmits it to the UE via a Timing Advance Command field of an RAR (Random Access Response).

Adjustment of TA in an RRC connected state: although the UE achieves uplink synchronization with the eNB/gNB in the random access process, a timing of an uplink signal arriving the eNB/gNB may change over time. Therefore, the UE needs to continuously update its uplink timing advance, to maintain the uplink synchronization. If the TA of a certain UE needs to be corrected, the eNB/gNB will transmit a Timing Advance Command to the UE, for requesting the UE to adjust the uplink timing. The Timing Advance Command is transmitted to the UE by the Timing Advance Command MAC CE (Medium Access Control Control Element).

TA maintenance in the NTN.

In the traditional TN network, the UE performs the TA maintenance based on a TA command transmitted by the network. For Rel-17 NTN, assuming that UEs all have a GNSS positioning capability and a TA pre-compensation capability, the UE may estimate a service link TA based on the UE position and the position of the service satellite. Therefore, a TA determination manner combining an open loop and closed loop is introduced into the NTN. Based on the conclusions of the current standardization meeting, for NTN UEs in the RRC_IDLE/INACTIVE and RRC_CONNECTED states, a timing advance (TA) of the UE is determined by the following formula:

$${T}_{TA} = ( {N}_{TA} + {N}_{TA , UE - specific} + {N}_{TA , common} + {N}_{TA , offset} ) \times {T}_{c} .$$

Herein, N_{TA} is defined as 0 for a scenario of the PRACH transmission, and may be updated later by a TA command in the Msg2/MsgB and a TA command MAC CE.

N_{TA}. CE-specific is a service link TA estimated by the UE itself, used for the TA pre-compensation. For example, the terminal will acquire a position of the satellite according to GNSS position information acquired by itself in combination with satellite ephemeris information broadcasted by a service cell, so as to calculate a propagation delay of the service link from the UE to the satellite.

N_{TA, common} is a common TA controlled by the network, which contains any timing deviation deemed necessary by the network.

N_{TA, offset} is a fixed offset for calculating the TA.

From the above TA calculation formula, it can be seen that UE in the RRC connected state, in order to acquire the service link TA (i.e., N_{TA, UE-specific}), on the one hand, needs to know its own GNSS position information, and on the other hand, also needs to acquire the position of the service satellite by the satellite ephemeris information of the service cell. In addition, in order to calculate the TA of the UE, the UE also needs to acquire the common TA (i.e., N_{TA, common}).

GNSS operation of R17 IoT NTN:

In the R17 IoT NTN (i.e., a scenario where NB-IoT (NarrowBand Internet of Things) and eMTC (Enhanced Machine Type Communication) access to the NTN), a GNSS measurement module and a communication module of the IoT terminal cannot operate simultaneously (Simultaneous GNSS and NTN NB-IoT/eMTC operation is not assumed). In the R17 NTN, the IoT terminal can perform the GNSS measurement to acquire position information only in the RRC IDLE or RRC INACTIVE state, but cannot start the GNSS module in the RRC connected state. Therefore, the UE needs to measure and acquire its own GNSS position by the GNSS module first before entering the RRC connected state. The UE may determine a valid duration of the GNSS position according to its own conditions (such as the UE mobility state), and report valid remaining time of the GNSS position to the network when the RRC establishment/RRC re-establishment/RRC connection resumption. For the UE in the RRC connected state, when its GNSS position expires, since the UE cannot perform the GNSS operation in the RRC connected state, the UE cannot calculate the TA, so the UE needs to return to the RRC IDLE state.

Ephemeris information/common TA acquisition mechanism of R17 IoT NTN.

In NTN, ephemeris information of a serving cell satellite and a common TA related parameter are notified to the UE by system broadcast. For IoT NTN, ephemeris information of the service satellite is carried in SIB31. Since the ephemeris information and the common TA related parameter need to be updated frequently, a concept of ephemeris information/common TA validity period is introduced. When the ephemeris information and/or the common TA related parameter previously acquired by the UE exceeds the validity period, the UE needs to re-read the SIB31. For example, the network configures durations of timers T317 and T318, where a duration of the T317 is a validity duration of the ephemeris information/common TA, and the T318 is maximum time allowed for the UE to re-read the SIB31 after the ephemeris information/common TA maintained by the UE expires.

For the UE in the RRC connected state, after reading the SIB31, the UE starts the T317 at the epoch time indicated by the SIB31. During the running of the T317, the ephemeris information and common TA maintained by the UE are considered to be valid. The UE may calculate its own TA according to the TA formula and perform the TA compensation.

When the T317 is exceeded, since the previously acquired ephemeris information and common TA parameter have expired, at this time, the UE is considered to be out of uplink sync. A UE RRC layer needs to notify an MAC layer to stop all UL transmissions, and meanwhile, start the T318, to re-read the SIB31.

If the UE has re-read the SIB31, the UE stops the T318, and meanwhile, starts the T317 at the epoch time indicated by the SIB31, and notifies the MAC layer to resume the uplink transmissions.

If the T318 times out, the UE triggers an RLF.

### GNSS Enhancement of R18 IoT NTN:

In the enhancement of R18 IoT NTN, the following research objectives are definitely given.

4.1.1 IoT-NTN Performance Enhancements in Rel-18 to address remaining issues from Rel-17

This work considers Rel-17 IoT-NTN as baseline as well as Rel-17 NR-NTN outcome and the further IoT-NTN performance enhancements objectives are listed below:
Disabling of HARQ feedback to mitigate impact of HARQ stalling on UE data rates [RAN1,RAN2]
Study and specify, if needed, improved GNSS operations for a new position fix for UE pre-compensation during long connection times and for reduced power consumption [RAN1]

Based on the above research objectives, the IoT terminal accessing to NTN in R18 will be able to perform the GNSS operation in the RRC connected state.

In the 3GPP RAN1#109 meeting, RAN1 discussed the GNSS enhancement of the IoT terminal accessing to NTN, and reached the following conclusions:

The IoT NTN UE may need to re-acquire valid GNSS position fix during the RRC connection with a longer duration. How does the UE update the GNSS position fix or reduce the requirement FFS for updating the GNSS position fix during the RRC connected state.

For the GNSS measurement in the connected state, at least the following candidate schemes may be considered:
Method 1: the UE based on timer control re-acquires the GNSS position fix;
Method 2: by introducing a new gap, during the gap, the UE re-acquires the GNSS position fix.

For the trigger of the GNSS measurement in the connected state, it may be considered that:
a GNSS measurement triggered by the UE.
a GNSS measurement triggered by the network.

Generally speaking, the number of connections supported by the traditional communication system is limited and is easy to be implemented, however, with the development of the communication technology, the mobile communication system will not only support the traditional communication, but also will support, for example, Device to Device (D2D) communication, Machine to Machine (M2M) communication, Machine Type Communication (MTC), Vehicle to Vehicle (V2V) communication, or Vehicle to everything (V2X) communication, etc., and the embodiments of the present disclosure may also be applied to these communication systems.

As an example but not a limitation, in the embodiments of the present disclosure, the terminal device may also be a wearable device. The wearable device, which may be also referred to as a wearable smart device, is a generic term for a device that can be worn, which is designed and developed intelligently from the daily wear by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions by software supporting, data interaction, and cloud interaction. The generalized wearable smart device includes for example, a smartwatch or smart glasses, etc., with full functions, large size, and entire or partial functions implemented without relying on a smartphone, as well as, for example, a smart bracelet and smart jewelry, etc., for physical sign monitoring, which only focuses on a certain type of application function and needs to be used by matching with other devices such as a smartphone.

In the embodiments of the present disclosure, the network device may be a device used to communicate with mobile devices. The network device may be an Access Point (AP) in the WLAN, a base station (Base Transceiver Station, BTS) in the GSM or CDMA, or may also be a base station (NodeB, NB) in the WCDMA, or may also be an evolutionary base station (Evolutionary Node B, eNB or eNodeB) in the LTE, or a relay station or an access point, or a vehicle-mounted device, a wearable device, and a network device (gNB) in an NR network, or a network device in the PLMN (Public Land Mobile Network) network evolved in the future or a network device in the NTN network, etc.

As an example but not a limitation, in the embodiments of the present disclosure, the network device may have a mobile characteristic, for example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. Optionally, the network device may also be a base station provided on land, water, and other places.

In the embodiments of the present disclosure, the network device may provide a service for a cell, and the terminal device communicates with the network device by a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc., and these small cells have characteristics of a small coverage range and low transmission power, which are applicable for providing a data transmission service with high speed.

In the embodiments, a method for resolving a conflict between a measurement and a communication of a terminal device is provided, which includes:
determining, by the terminal device, whether to start a second timer according to whether the terminal device is in a global navigation satellite system (GNSS) measurement period, in a case where a first timer times out, where the second timer is used by the terminal device to acquire system information within valid time of the second timer.

In some embodiments, determining, by the terminal device, whether to start the second timer according to whether the terminal device is in the GNSS measurement period, includes:
in a case where the first timer times out and the terminal device is not in the GNSS measurement period, starting, by the terminal device, the second timer.

In some embodiments, after the terminal device starts the second timer, when the terminal determines to trigger a GNSS measurement, the method further includes:
maintaining, by the terminal device, the second timer, and acquiring the system information within remaining valid time; and
when the terminal device has acquired the system information within the remaining valid time, starting, by the terminal device, the GNSS measurement.

In some embodiments, after the terminal device starts the second timer, when the terminal determines to trigger a GNSS measurement, the method further includes:
stopping, by the terminal device, the second timer, and starting the GNSS measurement.

In some embodiments, after the terminal device starts the GNSS measurement, the terminal device performs the GNSS measurement within GNSS measurement time.

In some embodiments, the GNSS measurement time includes one of:
valid time of a GNSS measurement timer; or
a GNSS measurement interval.

In some embodiments, performing, by the terminal device, the GNSS measurement within the GNSS measurement time, includes:
when GNSS position fix is completed within the GNSS measurement time, completing, by the terminal device, downlink synchronization with a network device.

In some embodiments, performing, by the terminal device, the GNSS measurement within the GNSS measurement time, includes:
when the GNSS position fix is not completed within the GNSS measurement time, entering, by the terminal device, an idle state or triggering a radio link failure (RLF); and
continuing, by the terminal device, the GNSS position fix.

In some embodiments, after the terminal device stops the second timer and starts the GNSS measurement, the method further includes:
when the terminal device completes GNSS position fix within the GNSS measurement time, restarting, by the terminal device, the second timer, or
when the terminal device completes GNSS position fix within the GNSS measurement time, resuming, by the terminal device, the second timer, and acquiring the system information within remaining valid time.

In some embodiments, after the terminal device stops the second timer and starts the GNSS measurement, the method further includes:
after the terminal device completes the downlink synchronization, restarting, by the terminal device, the second timer, or
after the terminal device completes the downlink synchronization, resuming, by the terminal device, the second timer, and acquiring the system information within remaining valid time.

In some embodiments, after the terminal device acquires the system information within the valid time of the second timer and a condition that a GNSS position of the terminal is valid is satisfied, the terminal device resumes uplink synchronization with a network device.

In some embodiments, when the terminal device does not acquire the system information within the valid time of the second timer, the method further includes:
triggering, by the terminal device, an RLF.

In some embodiments, the method further includes:
receiving, by the terminal device, configuration information transmitted by a network device, where the configuration information includes first timer information for running of the first timer and second timer information for running of the second timer.

In some embodiments, the first timer includes: a T317 timer; and the second timer includes: a T318 timer.

In some embodiments, the system information at least includes: a system information block (SIB) 31.

In the embodiments, a method for resolving a conflict between a measurement and a communication of a terminal device is provided, which includes:
determining, by the terminal device, starting time of a second timer and/or a duration of the second timer, when a first timer times out, in a case where the terminal device starts a GNSS measurement, where the second timer is used by the terminal device to acquire system information within valid time of the second timer.

In some embodiments, after the terminal device starts the GNSS measurement, the terminal device performs the GNSS measurement within GNSS measurement time.

In some embodiments, the GNSS measurement time includes one of:
valid time of a GNSS measurement timer; or
a GNSS measurement interval.

In some embodiments, performing, by the terminal device, the GNSS measurement within the GNSS measurement time, includes:
when GNSS position fix is completed within the GNSS measurement time, completing, by the terminal device, downlink synchronization with a network device.

In some embodiments, performing, by the terminal device, the GNSS measurement within the GNSS measurement time, includes:
when GNSS position fix is not completed within the GNSS measurement time, entering, by the terminal device, an idle state or triggering a radio link failure (RLF);
continuing, by the terminal device, the GNSS position fix.

In some embodiments, the method further includes one of:
starting, by the terminal device, the second timer, when the first timer times out;
starting, by the terminal device, the second timer, when completing the GNSS position fix;
starting, by the terminal device, the second timer, when completing the GNSS position fix and completing the downlink synchronization;
starting, by the terminal device, the second timer, after the first timer times out and before completing the GNSS position fix;
starting, by the terminal device, the second timer, after completing the GNSS position fix and before completing the downlink synchronization; or
starting, by the terminal device, the second timer, after completing the downlink synchronization.

In some embodiments, in a case where the terminal device starts the second timer when the first timer times out, the valid time includes one of:
first valid time with starting time being a first moment when the GNSS position fix is completed;
second valid time with starting time being a second moment after the GNSS position fix is completed and before the downlink synchronization is completed;
third valid time with starting time being a third moment when the downlink synchronization is completed; or
fourth valid time with starting time being a fourth moment after the downlink synchronization is completed and before the second timer times out.

In some embodiments, in a case where the terminal device starts the second timer when completing the GNSS position fix, the valid time includes one of:
first valid time with starting time being a first moment when the GNSS position fix is completed;
second valid time with starting time being a second moment after the GNSS position fix is completed and before the downlink synchronization is completed;
third valid time with starting time being a third moment when the downlink synchronization is completed; or
fourth valid time with starting time being a fourth moment after the downlink synchronization is completed and before the second timer times out.

In some embodiments, in a case where the terminal device starts the second timer when completing the downlink synchronization, the valid time includes one of:
third valid time with starting time being a third moment when the downlink synchronization is completed; or
fourth valid time with starting time being a fourth moment after the downlink synchronization is completed and before the second timer times out.

In some embodiments, in a case where the terminal device starts the second timer after the first timer times out and before the GNSS position fix is completed, the valid time includes one of:
first valid time with starting time being a first moment when the GNSS position fix is completed;
second valid time with starting time being a second moment after the GNSS position fix is completed and before the downlink synchronization is completed;
third valid time with starting time being a third moment when the downlink synchronization is completed; or
fourth valid time with starting time being a fourth moment after the downlink synchronization is completed and before the second timer times out.

In some embodiments, in a case where the terminal device starts the second timer after completing the GNSS position fix and before completing the downlink synchronization, the valid time includes one of:
second valid time with starting time being a second moment after the GNSS position fix is completed and before the downlink synchronization is completed;
third valid time with starting time being a third moment when the downlink synchronization is completed; or
fourth valid time with starting time being a fourth moment after the downlink synchronization is completed and before the second timer times out.

In some embodiments, in a case where the terminal device starts the second timer after completing the downlink synchronization, the valid time includes:
fourth valid time with starting time being a fourth moment after the downlink synchronization is completed and before the second timer times out.

In some embodiments, after the terminal device starts the second timer, when the terminal determines to trigger the GNSS measurement, the method further includes:
maintaining, by the terminal device, the second timer and acquiring the system information within remaining valid time; and
when the terminal device has acquired the system information within the remaining valid time, starting, by the terminal device, the GNSS measurement.

In some embodiments, after the terminal device starts the second timer, when the terminal determines to trigger the GNSS measurement, the method further includes:
stopping, by the terminal device, the second timer, and starting the GNSS measurement.

In some embodiments, after the terminal device acquires the system information within the valid time of the second timer and a condition that a GNSS position of the terminal is valid is satisfied, the terminal device resumes uplink synchronization with a network device.

In some embodiments, when the terminal device does not acquire the system information within the valid time of the second timer, the method further includes:
triggering, by the terminal device, an RLF.

In some embodiments, the method further includes:
receiving, by the terminal device, configuration information transmitted by a network device, where the configuration information includes first timer information for running of the first timer and second timer information for running of the second timer.

In some embodiments, the terminal determines a duration of the second timer according to the configuration information and remaining time of GNSS measurement time, or
the terminal determines a duration of the second timer according to the configuration information, remaining time of GNSS measurement time, and downlink synchronization time.

In some embodiments, the first timer includes: a T317 timer; and the second timer includes: a T318 timer.

In some embodiments, the system information at least includes: a system information block (SIB) 31.

### Embodiment 1

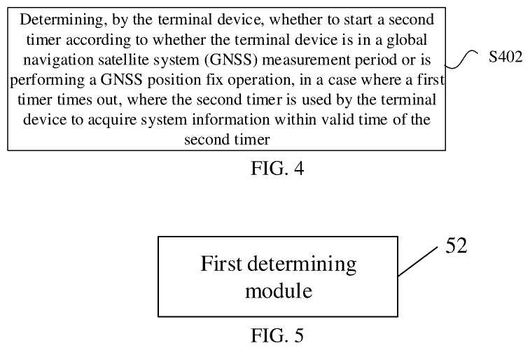

FIG. 4 is a flow chart of a method for resolving a conflict between a measurement and a communication of a terminal device according to the embodiments of the present disclosure. As shown in FIG. 4, the process includes the following steps:
step 402: determining, by the terminal device, whether to start a second timer according to whether the terminal device is in a global navigation satellite system (GNSS) measurement period or is performing a GNSS position fix operation, in a case where a first timer times out, where the second timer is used by the terminal device to acquire system information within valid time of the second timer.

It should be noted that, in the present disclosure, the terminal device needs to perform the GNSS positioning (position fix) operation in the GNSS measurement period.

The system information described in the present disclosure at least includes: a system information block SIB31. Of course, considering the continuity of the technology, any information that can be used to provide the terminal device with ephemeris information of the service satellite is within the protection scope of this embodiment. In addition, similarly, to consider the continuity of the technology, any manner of information for transmitting the ephemeris information of the service satellite by broadcasting, multicasting or unicasting is within the protection scope of the embodiments of the present disclosure.

The first timer described in this embodiment includes at least a T317 timer. The second timer includes at least a T318 timer. Of course, considering the continuity of the technology, any timer that can be used by the terminal device to maintain the ephemeris information and common TA to be valid, as well as any timer that can be used to acquire the SIB31, are within the protection scope of the present disclosure, and not limited to the T317 timer and the T318 timer.

Determining, by the terminal device, whether to start the second timer according to whether the terminal device is in the GNSS measurement period, includes: in a case where the first timer times out and the terminal device determines that the terminal device is not in the GNSS measurement period, starting, by the terminal device, the second timer.

Determining, by the terminal device, whether to start the second timer according to whether the terminal device is in the GNSS measurement period, includes: in a case where the first timer times out and the terminal device is not in the GNSS measurement period, starting, by the terminal device, the second timer.

After the terminal device starts the second timer, when the terminal determines that the terminal device triggers a GNSS measurement, the method further includes: maintaining, by the terminal device, the second timer, and acquiring the system information within remaining valid time; when the terminal device has acquired the system information within the remaining valid time, starting, by the terminal device, the GNSS measurement.

After the terminal device starts the second timer, when the terminal determines that the terminal device triggers a GNSS measurement, the method further includes: stopping, by the terminal device, the second timer, and starting the GNSS measurement.

After the terminal device starts the GNSS measurement, the terminal device performs the GNSS measurement within GNSS measurement time.

The GNSS measurement time includes one of: valid time of a GNSS measurement timer; or a GNSS measurement interval.

It should be noted that, performing, by the terminal device, the GNSS measurement within the GNSS measurement time, includes: when GNSS position fix is completed within the GNSS measurement time, completing, by the terminal device, downlink synchronization with a network device.

It should be noted that, performing, by the terminal device, the GNSS measurement within the GNSS measurement time, includes: when the GNSS position fix is not completed within the GNSS measurement time, entering, by the terminal device, an idle state or triggering a radio link failure (RLF); and continuing, by the terminal device, the GNSS position fix.

It should be noted that, after the terminal device stops the second timer and starts the GNSS measurement, the method further includes: when the terminal device completes GNSS position fix within the GNSS measurement time, restarting, by the terminal device, the second timer, or when the terminal device completes GNSS position fix within the GNSS measurement time, resuming, by the terminal device, the second timer, and acquiring the system information within remaining valid time.

It should be noted that, after the terminal device stops the second timer and starts the GNSS measurement, the method further includes: after the terminal device completes the downlink synchronization, restarting, by the terminal device, the second timer, or after the terminal device completes the downlink synchronization, resuming, by the terminal device, the second timer, and acquiring the system information within remaining valid time.

It should be noted that, after the terminal device acquires the system information within the valid time of the second timer and in a case where a condition that a GNSS position of the terminal device is valid is satisfied, the terminal device resumes uplink synchronization with a network device.

It should be noted that, when the terminal device does not acquire the system information within the valid time of the second timer, the method further includes: triggering, by the terminal device, an RLF.

It should be noted that, the terminal device receives configuration information transmitted by a network device, where the configuration information includes first timer information for running of the first timer and second timer information for running of the second timer.

### Embodiment 2

FIG. 5 is a structural block diagram of an apparatus for resolving a conflict between a measurement and a communication of a terminal device according to the embodiments of the present disclosure, which is located in the terminal device. As shown in FIG. 5, the apparatus includes:

a first determining module 52, configured to determine whether to start a second timer according to whether the terminal device is in a global navigation satellite system (GNSS) measurement period, in a case where a first timer times out, where the second timer is used by the terminal device to acquire system information within valid time of the second timer.

The apparatus further includes: a first starting module, configured to start the second timer in a case where the first timer times out and the terminal device determines that the terminal device is not in the GNSS measurement period, starting.

When the first determining module 52 determines that the terminal device triggers a GNSS measurement (for example, a GNSS position of the terminal device is invalid), the apparatus is further configured to: maintain the second timer, and acquire the system information within remaining valid time; and when the system information is acquired within the remaining valid time, start the GNSS measurement.

The apparatus further includes: a first stopping module, configured to stop the second timer and start a GNSS measurement, when the first determining module 52 determines that the terminal device triggers the GNSS measurement.

The apparatus further includes: a first measuring module, configured to perform the GNSS measurement within GNSS measurement time, after the GNSS measurement is started.

The GNSS measurement time includes one of: valid time of a GNSS measurement timer; or a GNSS measurement interval.

The apparatus further includes: a first downlink synchronizing module, configured to complete downlink synchronization with a network device, after GNSS position fix is completed within the GNSS measurement time.

The apparatus further includes: a first triggering module, configured to enter an idle state or trigger a radio link failure (RLF), when the GNSS position fix is not completed within the GNSS measurement time; and a first positioning module, configured to continue the GNSS position fix.

The apparatus further includes: a first restarting module, configured to restart the second timer when GNSS position fix is completed within the GNSS measurement time, or a first resuming module, configured to resume the second timer, and acquire the system information within remaining valid time, when GNSS position fix is completed within the GNSS measurement time.

The apparatus further includes: a second restarting module, configured to restart the second timer, after the downlink synchronization is completed, or a second restarting module, configured to resume the second timer and acquire the system information within remaining valid time, after the downlink synchronization is completed.

The apparatus further includes: a second resuming module, configured to resume uplink synchronization with a network device after the system information is acquired within the valid time of the second timer.

The apparatus further includes: a second triggering module, configured to trigger an RLF when the system information is not acquired within the valid time of the second timer.

The apparatus further includes: a first receiving module, configured to receive configuration information transmitted by a network device, where the configuration information includes first timer information for running of the first timer and second timer information for running of the second timer.

Optionally, the present disclosure further provides the following scenarios for Embodiment 1 and Embodiment 2, to better understand the solutions described in the above embodiments.

### Scenario 1.

The terminal device determines that the T317 timer times out in the GNSS validity period, and at this time, the ephemeris information of the service satellite and the common TA related parameter maintained have become invalid. The UE needs to start the T318 timer to acquire the ephemeris information of the service satellite and the common TA related parameter carried in the SIB31.

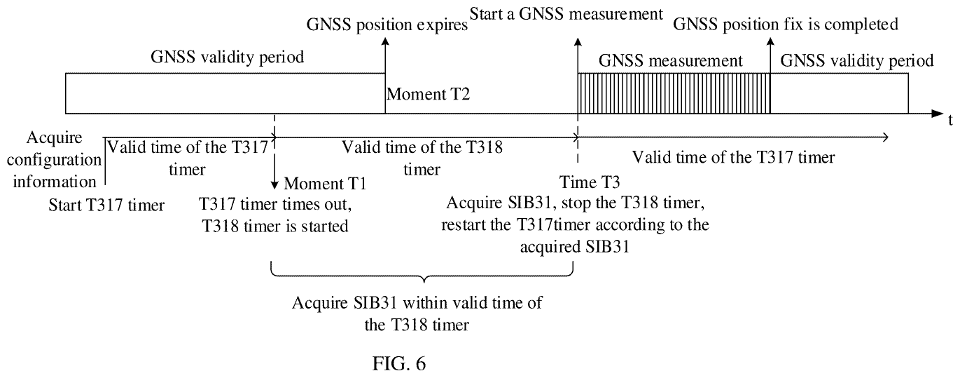

FIG. 6 is a timing diagram of a terminal device running based on scenario 1 according to the embodiments of the present disclosure. As shown in FIG. 6, the exemplary scenario is as follows.

The terminal device in the connected state receives configuration information transmitted by the network device. Configuration information for the T317 timer and configuration information for the T318 timer are included.

According to the configuration information of the T317 timer, the terminal device runs the T317 timer to maintain the ephemeris information of the service satellite and the common TA parameter. At the same time, the terminal device is maintaining the GNSS position.

At a moment T1, the T317 timer times out. Since the previously acquired ephemeris information and common TA parameter have expired, it is determined that the out of uplink sync occurs. Therefore, the terminal device starts the T318 timer, and re-reads SIB31 within valid time of the T318 timer.

At a moment T2, the terminal device triggers a GNSS measurement and keeps re-reading the SIB31 within the valid time of the T318 timer.

At a moment T3, the terminal device acquires the SIB31, stops the T318 timer, restarts the T317 timer according to the acquired SIB31, and maintains the ephemeris information of the service satellite and the common TA parameter. At the same time, the terminal device starts the GNSS measurement.

The terminal device performs the GNSS measurement within the valid time of the GNSS measurement timer or the GNSS measurement interval. When the GNSS position fix is completed, the terminal device re-maintains the GNSS position and completes the downlink synchronization with the network device.

It should be noted that, in order to reduce the running burden of the terminal device, the terminal device may not start the GNSS measurement immediately at the moment T3, but may start the GNSS measurement after a time length t1 after the moment T3.

It should be noted that, when it is determined that the terminal is out of uplink sync, the RRC layer of the terminal will notify the MAC layer to stop all uplink transmissions.

It should be noted that the configuration information of the T317 timer and the configuration information of the T318 timer may be transmitted via a same signaling or message, or may be transmitted via different signalings or messages.

### Scenario 2.

The terminal device determines that the T317 timer times out in the GNSS validity period, and at this time, the ephemeris information of the service satellite and the common TA related parameter maintained have become invalid. The UE acquires the SIB31 within the valid time after starting the T318 timer. However, at a moment T2 when the terminal device has not yet acquired the SIB31, the terminal device determines that the GNSS position is invalid. At this time, the terminal device also needs to re-perform the GNSS measurement to acquire the GNSS position fix.

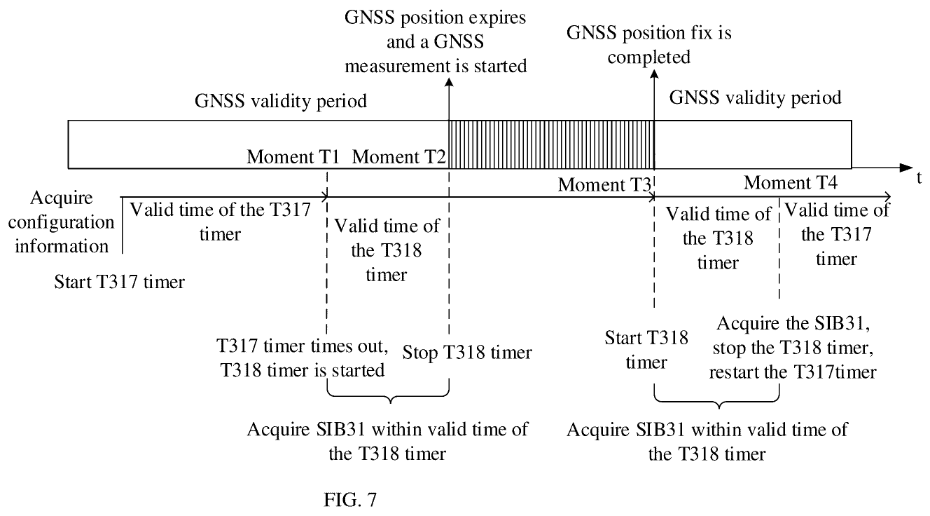

FIG. 7 is a timing diagram of a terminal device running based on scenario 2 according to the embodiments of the present disclosure. As shown in FIG. 7, the exemplary scenario is as follows.

According to the configuration information of the T317 timer, the terminal device runs the T317 timer to maintain the ephemeris information of the service satellite and common TA parameter. At the same time, the terminal device is maintaining the GNSS position.

At a moment T1, the T317 timer times out. Since the previously acquired ephemeris information and common TA parameter have expired, it is determined that the out of uplink sync occurs. Therefore, the terminal device starts the T318 timer and re-reads SIB31 within the valid time of the T318 timer.

At a moment T2, the terminal device triggers the GNSS measurement. At this time, the terminal device has not yet acquired the SIB31. The terminal device stops the T318 timer and starts the GNSS measurement.

At a moment T3, the terminal device completes the GNSS position fix, and the terminal device re-maintains the GNSS position. At the same time, the terminal device may resume the T318 timer and continue to acquire the SIB31 within the remaining valid time of the T318 timer, or the terminal device may restart the T318 timer and acquire the SIB31 within an entire valid time of the T318 timer.

At a moment T4, the terminal device acquires the SIB31, stops the T318 timer, restarts the T317 timer according to the acquired SIB31, maintains the ephemeris information of the service satellite and the common TA parameter, and resumes the uplink synchronization with the network device. Then, the terminal device completes the downlink synchronization with the network device.

It should be noted that, in order to reduce the running burden of the terminal device, the terminal device may not start the T318 timer immediately at the moment T3, but may start the T318 timer after a time length t2 after the moment T3.

It should be noted that, when it is determined that the terminal is out of uplink sync, the RRC layer of the terminal will notify the MAC layer to stop all uplink transmissions.

It should be noted that the configuration information of the T317 timer and the configuration information of the T318 timer may be transmitted via a same signaling or message, or may be transmitted via different signalings or messages.

### Embodiment 3

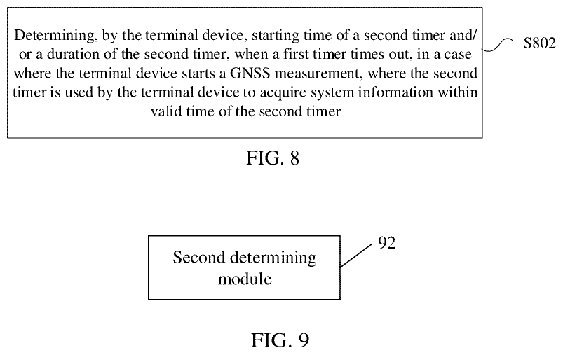

FIG. 8 is a flow chart of a method for resolving a conflict between a measurement and a communication of a terminal device according to the embodiments of the present disclosure. As shown in FIG. 8, the process includes the following steps:
step 802, determining, by the terminal device, starting time of a second timer and/or a duration of the second timer, when a first timer times out, in a case where the terminal device starts a GNSS measurement, where the second timer is used by the terminal device to acquire system information within valid time of the second timer.

The system information described in the present disclosure at least includes: a system information block SIB31. Of course, considering the continuity of the technology, any information that can be used to provide the terminal device with ephemeris information of the service satellite is within the protection scope of this embodiment. In addition, similarly, to consider the continuity of the technology, any manner of information for transmitting the ephemeris information of the service satellite by broadcasting, multicasting or unicasting is within the protection scope of the embodiments of the present disclosure.

The first timer described in this embodiment includes at least a T317 timer. The second timer includes at least a T318 timer. Of course, considering the continuity of the technology, any timer that can be used by the terminal device to maintain the ephemeris information and common TA to be valid, as well as any timer that can be used to acquire the SIB31, are within the protection scope of the present disclosure, and not limited to the T317 timer and the T318 timer.

After the terminal device starts a GNSS measurement, the terminal device performs the GNSS measurement within GNSS measurement time.

The GNSS measurement time includes one of: valid time of a GNSS measurement timer; or a GNSS measurement interval.

Performing, by the terminal device, the GNSS measurement within the GNSS measurement time, includes: when GNSS position fix is completed within the GNSS measurement time, completing, by the terminal device, downlink synchronization with a network device.

Performing, by the terminal device, the GNSS measurement within the GNSS measurement time, includes: when GNSS position fix is not completed within the GNSS measurement time, entering, by the terminal device, an idle state or triggering a radio link failure (RLF); continuing, by the terminal device, the GNSS position fix.

The method further includes one of: starting, by the terminal device, the second timer, when the first timer times out; starting, by the terminal device, the second timer, when completing the GNSS position fix; starting, by the terminal device, the second timer, when completing the GNSS position fix and completing the downlink synchronization; starting, by the terminal device, the second timer, after the first timer times out and before the GNSS position fix; starting, by the terminal device, the second timer, after completing the GNSS position fix and before completing the downlink synchronization; or starting, by the terminal device, the second timer, after completing the downlink synchronization.

In a case where the terminal device starts the second timer when the first timer times out, the valid time includes one of: first valid time with starting time being a first moment when the GNSS position fix is completed; second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case where the terminal device starts the second timer when completing the GNSS position fix, the valid time includes one of: first valid time with starting time being a first moment when the GNSS position fix is completed; second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case where the terminal device starts the second timer when completing the downlink synchronization, the valid time includes one of: third valid time with starting time being a third moment when the downlink synchronization is completed; or fourth valid time with starting time being a fourth moment after the downlink synchronization is completed and before the second timer times out.

In a case where the terminal device starts the second timer after the first timer times out and before the GNSS position fix, the valid time includes one of: first valid time with starting time being a first moment when the GNSS position fix is completed; second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case where the terminal device starts the second timer after completing the GNSS position fix and before completing the downlink synchronization, the valid time includes one of: second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case where the terminal device starts the second timer after completing the downlink synchronization, the valid time includes one of: fourth valid time with starting time being a fourth moment after the downlink synchronization is completed and before the second timer times out.

After the terminal device starts the second timer, when the terminal determines that the terminal device triggers the GNSS measurement, the method further includes: maintaining, by the terminal device, the second timer and acquiring the system information within remaining valid time; and when the terminal device has acquired the system information within the remaining valid time, starting, by the terminal device, the GNSS measurement.

After the terminal device starts the second timer, when the terminal determines that the terminal device triggers the GNSS measurement, the method further includes: stopping, by the terminal device, the second timer, and starting the GNSS measurement.

After the terminal device acquires the system information within the valid time of the second timer and a condition that a GNSS position of the UE is valid is satisfied, the terminal device resumes uplink synchronization with a network device.

When the terminal device does not acquire the system information within the valid time of the second timer, the method further includes: triggering, by the terminal device, an RLF.

The method further includes: receiving, by the terminal device, configuration information transmitted by a network device, where the configuration information includes first timer information for running of the first timer and second timer information for running of the second timer.

The terminal determines a duration of the second timer according to the configuration information and remaining time of GNSS measurement time, or the terminal determines a duration of the second timer according to the configuration information, remaining time of GNSS measurement time, and downlink synchronization time.

FIG. 9 is a structural block diagram of an apparatus for resolving a conflict between a measurement and a communication of a terminal device according to the embodiments of the present disclosure, which is located in the terminal device. As shown in FIG. 9, the apparatus includes:
a second determining module 92, configured to configured to determine starting time of a second timer and/or a duration of the second timer, in a case where a GNSS measurement is started, when a first timer times out, where the second timer is used to acquire system information within valid time of the second timer.

The apparatus further includes: a second measurement module, configured to perform the GNSS measurement within GNSS measurement time, after the GNSS measurement is started.

The GNSS measurement time includes one of: valid time of a GNSS measurement timer; or a GNSS measurement interval.

The apparatus further includes: a second downlink synchronizing module, configured to complete downlink synchronization with a network device, when GNSS position fix is completed within the GNSS measurement time.

The apparatus further includes: a third trigger module, configured to enter an idle state or trigger a radio link failure (RLF), when GNSS position fix is not completed within the GNSS measurement time; and a second positioning module, configured to continue the GNSS position fix.

The apparatus further includes: a second starting module, configured to perform one operation of: starting the second timer when the first timer times out; starting the second timer when the GNSS position fix is completed; starting the second timer when the GNSS position fix is completed and the downlink synchronization is completed; starting the second timer after the first timer times out and before the GNSS position fix; starting the second timer after the GNSS position fix is completed and before the downlink synchronization is completed; or starting the second timer after the downlink synchronization is completed.

The apparatus further includes: an acquiring module, configured to acquire the system information within the valid time.

In a case of starting the second timer when the first timer times out, the valid time includes one of: first valid time with starting time being a first moment when the GNSS position fix is completed; second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case of starting the second timer when the GNSS position fix is completed, the valid time includes one of: first valid time with starting time being a first moment when the GNSS position fix is completed; second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case of starting the second timer after the downlink synchronization is completed, the valid time includes one of: third valid time with starting time being a third moment when the downlink synchronization is completed; or fourth valid time with starting time being a fourth moment after the downlink synchronization is completed and before the second timer times out.

In a case of starting the second timer after the first timer times out and before the GNSS position fix, the valid time includes one of: first valid time with starting time being a first moment when the GNSS position fix is completed; second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case of starting the second timer after the GNSS position fix is completed and before the downlink synchronization is completed, the valid time includes one of: second valid time with starting time being a second moment after the GNSS position fix is completed and before the downlink synchronization is completed; third valid time with starting time being a third moment when the downlink synchronization is completed; or fourth valid time with starting time being a fourth moment after the downlink synchronization is completed and before the second timer times out.

In a case of starting the second timer after the downlink synchronization is completed, the valid time includes one of: fourth valid time with starting time being a fourth moment after the downlink synchronization is completed and before the second timer times out.

The apparatus also includes: a maintaining module, configured to maintain the second timer and acquire the system information within remaining valid time, when it is determined to trigger the GNSS measurement (such as a GNSS position is invalid), after the second timer is started; and a third restarting module, configured to restart the GNSS measurement when the terminal device has acquired the system information within the remaining valid time.

The apparatus further includes: a second stopping module, configured to stop the second timer and restart the GNSS measurement, when it is determined to trigger the GNSS measurement (such as a GNSS position is invalid), after the second timer is started.

The apparatus further includes: a third resuming module, configured to resume uplink synchronization with a network device, after the system information is acquired within the valid time of the second timer and in a case where a condition that a GNSS position of the terminal is valid is satisfied.

The apparatus further includes: a fourth triggering module, configured to trigger an RLF when the system information is not acquired within the valid time of the second timer.

The apparatus further includes: a second receiving module, configured to receive configuration information transmitted by a network device, where the configuration information includes first timer information for running of the first timer and second timer information for running of the second timer.

The apparatus is further configured to determine a duration of the second timer according to the configuration information and remaining time of GNSS measurement time, or determine a duration of the second timer according to the configuration information, remaining time of GNSS measurement time, and downlink synchronization time.

### Scenario 3.

In a case where the terminal device starts the GNSS positioning function, the terminal device determines that the T317 timer times out, when the GNSS position is valid. The UE needs to start the T318 timer to acquire the SIB31 within the valid time.

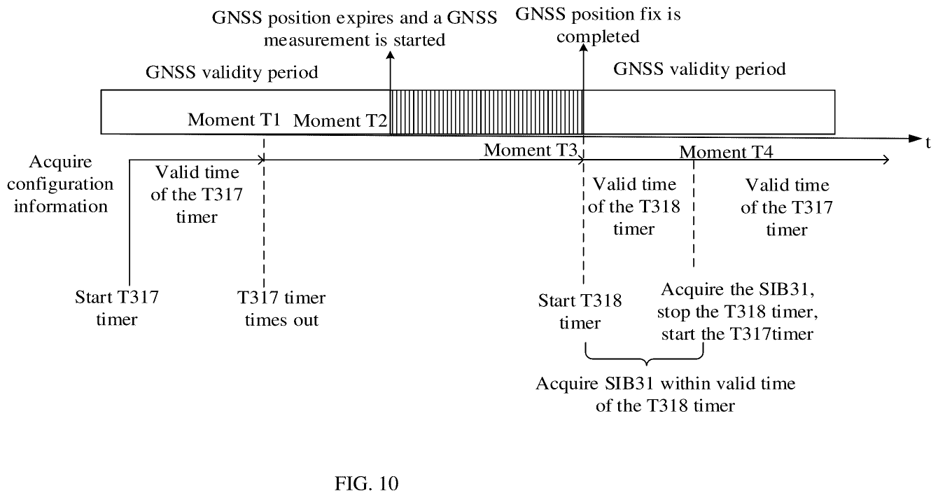

FIG. 10 is a timing diagram of a terminal device running based on scenario 3 according to the embodiments of the present disclosure. As shown in FIG. 10, the exemplary scenario is as follows.

The terminal device in the connected state receives configuration information transmitted by the network device. Configuration information for the T317 timer and configuration information for the T318 timer are included.

According to the configuration information of the T317 timer, the terminal device runs the T317 timer to maintain the ephemeris information of the service satellite and the common TA parameter. At the same time, the terminal device is maintaining the GNSS position.

At a moment T1, the T317 timer times out, and the previously acquired ephemeris information and common TA parameter have expired.

At a moment T2, the terminal device triggers the GNSS measurement (for example, because the GNSS position maintained by the terminal device expires). The terminal device performs the GNSS measurement within the valid time of the GNSS measurement timer or the GNSS measurement interval. When the GNSS position fix is completed, the terminal device re-maintains the GNSS position.

At a moment T3, the terminal device starts the T318 timer and re-reads SIB31 within the valid time of the T318 timer.

At a moment T4, the terminal device acquires the SIB31, stops the T318 timer, restarts the T317 timer according to the acquired SIB31, maintains the ephemeris information of the service satellite and the common TA parameter, and resumes the uplink synchronization with the network device. Then, the downlink synchronization with the network device is completed.

It should be noted that, when it is determined that the terminal is out of uplink sync, the RRC layer of the terminal will notify the MAC layer to stop all uplink transmissions.

It should be noted that the configuration information of the T317 timer and the configuration information of the T318 timer may be transmitted via a same signaling or message, or may be transmitted via different signalings or messages.

### Scenario 4.

In a case where the terminal device stars the GNSS positioning function, after the GNSS measurement is started, the terminal device determines that the T317 timer times out. The UE needs to start the T318 timer to acquire the SIB31 within the valid time.

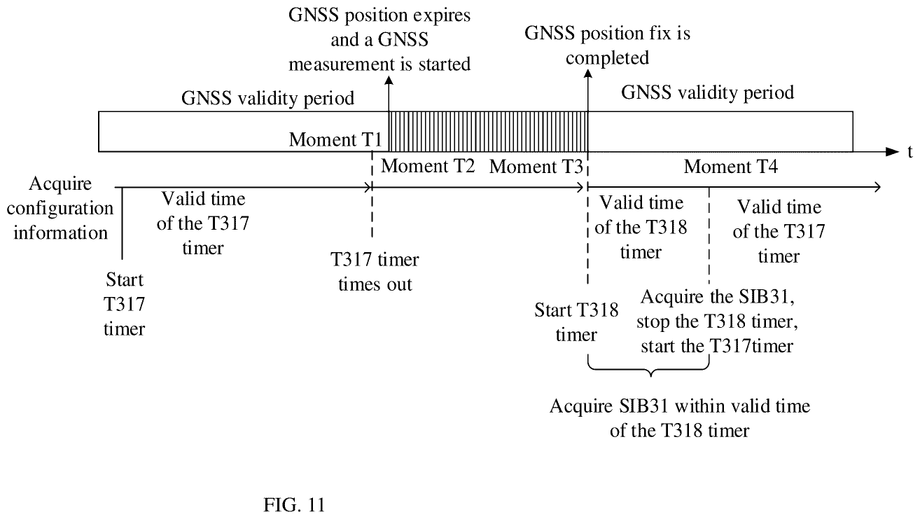

FIG. 11 is a timing diagram of a terminal device running based on scenario 4 according to the embodiments of the present disclosure. As shown in FIG. 11, the exemplary scenario is as follows.

The terminal device in the connected state receives configuration information transmitted by the network device. Configuration information for the T317 timer and configuration information for the T318 timer are included.

According to the configuration information of the T317 timer, the terminal device runs the T317 timer to maintain the ephemeris information of the service satellite and the common TA parameter. At the same time, the terminal device is maintaining the GNSS position.

At a moment T1, the terminal device triggers the GNSS measurement, for example, the GNSS position maintained by the terminal device expires. The terminal device performs the GNSS measurement within the valid time of the GNSS measurement timer or the GNSS measurement interval.

At a moment T2, the T317 timer times out, and the previously acquired ephemeris information and common TA parameters have expired.

At a moment T3, when the terminal device completes the GNSS position fix, the terminal device re-maintains the GNSS position. At the same time, the terminal device starts the T318 timer and re-reads SIB31 within the valid time of the T318 timer.

At a moment T4, the terminal device acquires the SIB31, stops the T318 timer, restarts the T317 timer according to the acquired SIB31, maintains the ephemeris information of the service satellite and the common TA parameter, and resumes the uplink synchronization with the network device. Then, the downlink synchronization with the network device is completed.

It should be noted that, when it is determined that the terminal is out of uplink sync, the RRC layer of the terminal will notify the MAC layer to stop all uplink transmissions.

It should be noted that the configuration information of the T317 timer and the configuration information of the T318 timer may be transmitted via a same signaling or message, or may be transmitted via different signalings or messages.

### Scenario 5.

Scenario 5 mainly makes flexible adjustments to positions of the starting moment and the valid duration of the T318 in scenario 3 to scenario 4. In scenario 5, when the T317 timer times out, the terminal device starts or is performing the GNSS measurement.

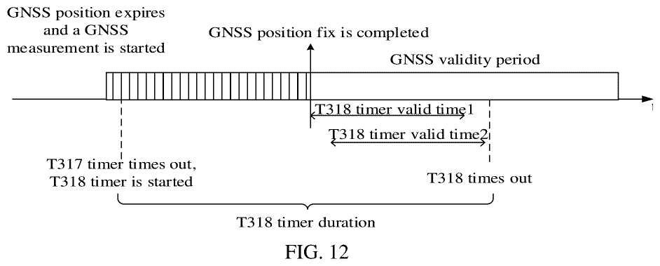

FIG. 12 to FIG. 15 are different timing diagrams of starting and valid time of the T318 timer according to the embodiments of the present disclosure, respectively.

In FIG. 12, a starting position of the T318 timer is the same as a timeout position of the T317 timer. At the same time, the terminal device may start to acquire the SIB31 within valid time 1 of the T318 timer, when the GNSS position fix is completed, or the terminal device may also start to acquire the SIB31 within valid time 2 of the T318 timer, after the GNSS position fix is completed.

In FIG. 12, the duration of the T318 timer is determined according to a sum of GNSS measurement time from the time when the T317 timer times out to the time when the GNSS position fix is completed and the configured T318 timer duration (the duration is a duration from the moment when the GNSS position fix is completed to the moment when the T318 times out).

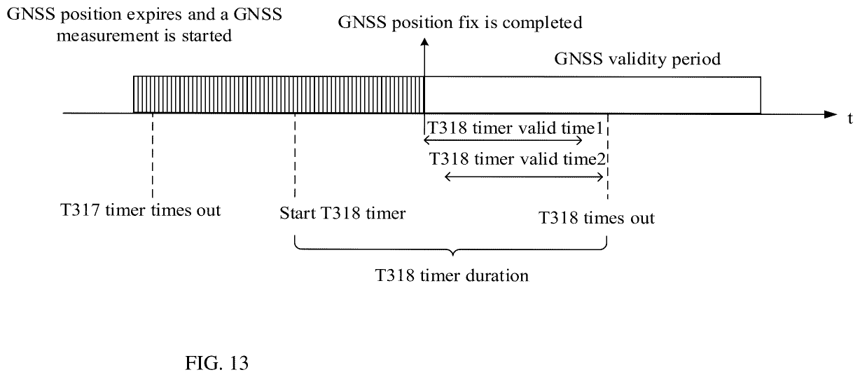

In FIG. 13, the starting position of the T318 timer is after the T317 timer times out, in the GNSS measurement period. At the same time, the terminal device may start to acquire the SIB31 within valid time 1 of the T318 timer, when the GNSS position fix is completed. The terminal device may also start to acquire the SIB31 within valid time 2 of the T318 timer, after the GNSS position fix is completed.

In FIG. 13, the duration of the T318 timer is determined according to a sum of the GNSS measurement time from the time when the T318 timer starts to the time when the GNSS position fix is completed and the configured T318 timer duration (the duration is a duration from the moment when the GNSS position fix is completed to the moment when the T318 times out).

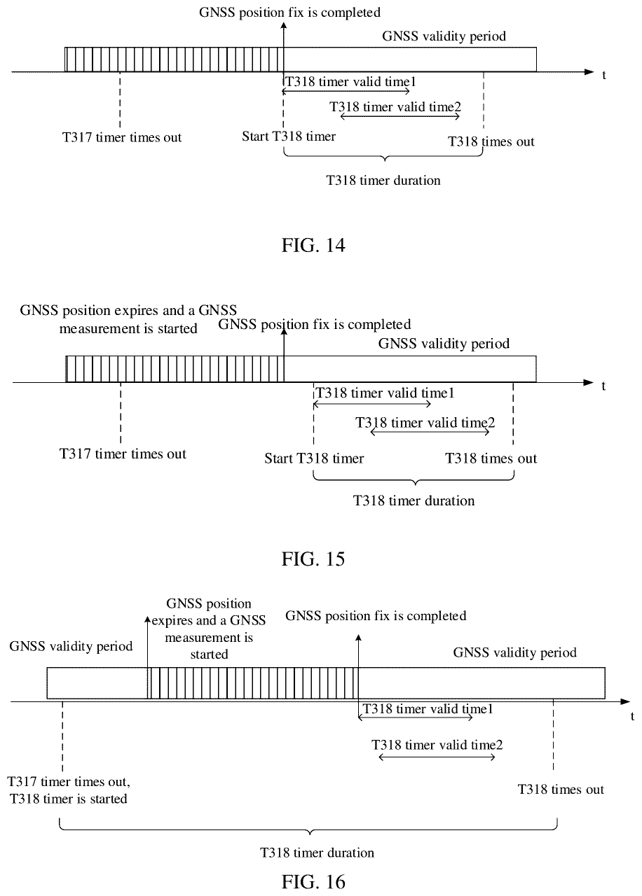

In FIG. 14, the starting position of the T318 timer is after the T317 timer times out and when the GNSS position fix is completed, and the terminal device may start to acquire the SIB31 within valid time 1 of the T318 timer, when the GNSS position fix is completed. The terminal device may also start to acquire the SIB31 within valid time 2 of the T318 timer, after the GNSS position fix is completed.

In FIG. 14, the configured T318 timer duration is determined according to the configured T318 timer duration.

In FIG. 15, the starting position of the T318 timer is after the T317 timer times out and after the GNSS position fix is completed, and the terminal device may start to acquire the SIB31 within valid time 1 of the T318 timer, when the T318 timer starts. The terminal device may also start to acquire the SIB31 within valid time 2 of the T318 timer, after the T318 timer starts.

In FIG. 15, the T318 timer duration is determined according to a difference between a configured T318 timer duration (the duration is a duration from the moment when GNSS position fix is completed to the moment when T318 times out) and the GNSS valid time from the moment when the GNSS positioning is completed to the moment when the T318 timer is started.

FIG. 16 to FIG. 21 are different timing diagrams of the starting and valid time of the T318 timer according to the embodiments of the present disclosure, respectively.

In FIG. 16, the T317 timer times out when the GNSS measurement is performed, and the T318 timer is started when the T317 timer times out. The terminal device may start to acquire the SIB31 within valid time 1 of the T318 timer, when the GNSS position fix is completed. The terminal device may also start to acquire the SIB31 within valid time 2 of the T318 timer, after the GNSS position fix is completed.

In FIG. 16, the duration of the T318 timer is determined according to a sum of the GNSS measurement time from the moment when the T317 timer times out to the moment when the GNSS position fix is completed, and a configured T318 timer duration (the duration is a duration from the moment when the GNSS position fix is completed to the moment when the T318 times out).

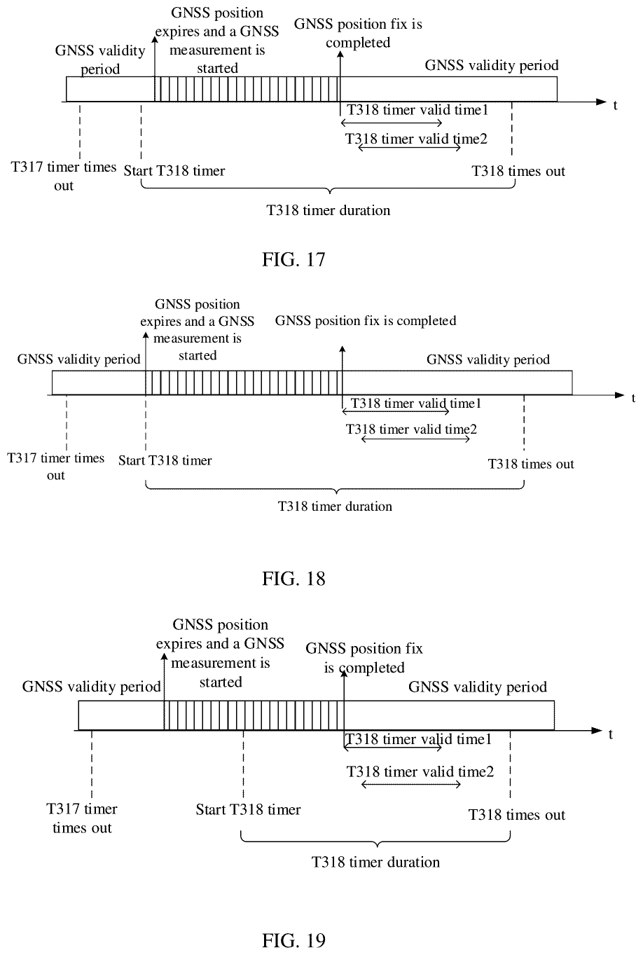

In FIG. 17, the T317 timer times out when the GNSS position is maintained, and the T318 timer is started during the GNSS measurement is performed and after the T317 timer times out. The terminal device may start to acquire the SIB31 within valid time 1 of the T318 timer, when the GNSS position fix is completed. The terminal device may start to acquire the SIB31 within valid time 2 of the T318 timer, after the GNSS position fix is completed.

FIG. 17 is similar to FIG. 16, the duration of the T318 timer is determined according to a sum of the GNSS measurement time from the moment when the T318 timer is started to the moment when the GNSS position fix is completed, and a configured T318 timer duration (the duration is a duration from the moment when the GNSS position fix is completed to the moment when the T318 times out).

In FIG. 18, the T317 timer times out during the GNSS measurement is performed, and the T318 timer is started when the GNSS measurement is started. The terminal device may start to acquire the SIB31 within valid time 1 of the T318 timer, when the GNSS position fix is completed. The terminal device may also start to acquire the SIB31 within valid time 2 of the T318 timer, after the GNSS position fix is completed.

In FIG. 18, the duration of the T318 timer is determined according to a sum of the GNSS measurement time from the moment when the T318 timer is started to the moment when the GNSS position fix is completed, and a configured T318 timer duration (the duration is a duration from the moment when the GNSS position fix is completed to the moment when T318 times out).

In FIG. 19, the T317 timer times out during the GNSS measurement is performed, and the T318 timer is started during the GNSS measurement is started. The terminal device may start to acquire the SIB31 within valid time 1 of the T318 timer, when the GNSS position fix is completed. The terminal device may also start to acquire the SIB31 within valid time 2 of the T318 timer, after the GNSS position fix is completed.

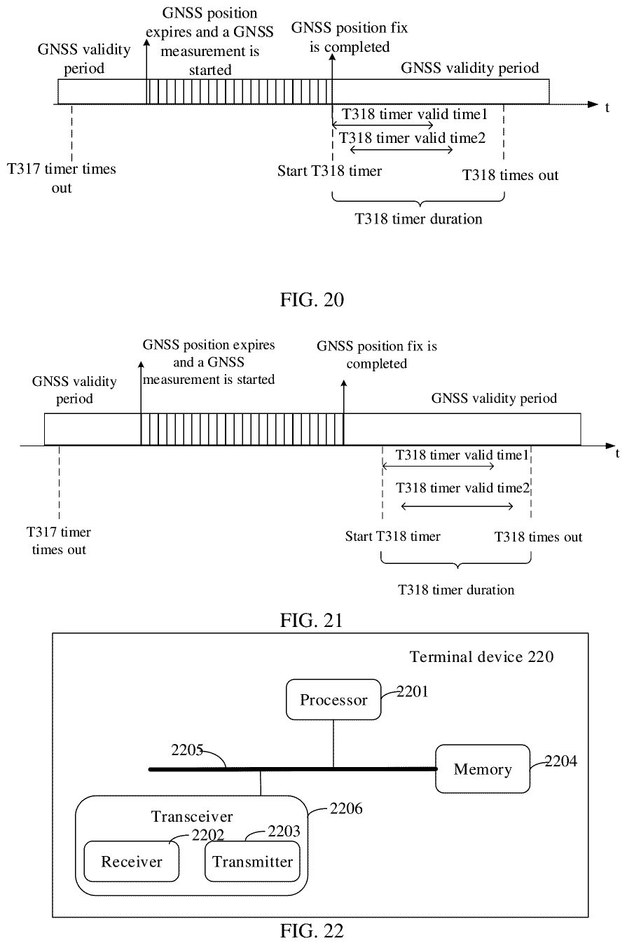

FIG. 19 is similar to FIG. 18, in FIG. 19, the duration of the T318 timer is determined according to a sum of the GNSS measurement time from the moment when the T318 timer is started to the moment when the GNSS position fix is completed, and a configured T318 timer duration (the duration is a duration from the moment when the GNSS position fix is completed to the moment when T318 times out). In FIG. 20, the T317 timer times out during the GNSS measurement is performed, and the T318 timer is started when the GNSS position fix is completed. The terminal device may start to acquire the SIB31 within valid time 1 of the T318 timer, when the GNSS position fix is completed. The terminal device may also start to acquire the SIB31 within valid time 2 of the T318 timer, after the GNSS position fix is completed.

Similar to FIG. 14, in FIG. 20, the configured T318 timer duration is determined according to the configured T318 timer duration. In FIG. 21, the T317 timer times out during the GNSS measurement is performed, and the T318 timer is started after the GNSS position fix is completed. The terminal device may start to acquire the SIB31 within valid time 1 of the T318 timer, when the T318 timer is started. The terminal device may also start to acquire the SIB31 within valid time 2 of the T318 timer, after the T318 timer is started.

Similar to FIG. 15, in FIG. 21, the T318 timer duration is determined according to a difference between a configured T318 timer duration (the duration is a duration from the moment when GNSS position fix is completed to the moment when T318 times out) and the GNSS valid time from the moment when the GNSS positioning is completed to the moment when the T318 timer is started.

It should be pointed out that, although not shown in the drawings, in the embodiments of the present scheme, on the basis of FIG. 12 to FIG. 14, FIG. 16 to FIG. 20 similarly, and on the basis of the T318 timer duration, the downlink synchronization time is added after the GNSS measurement. FIG. 22 is a structural schematic diagram of a terminal device according to the embodiments of the present disclosure. As shown in FIG. 22, the terminal device may be configured to perform the above-mentioned method for resolving a conflict between a measurement and a communication of a terminal device. For example, the terminal device 220 may include: a processor 2201, a receiver 2202, a transmitter 2203, a memory 2204 and a bus 2205.

The processor 2201 includes one or more processing cores. The processor 2201 executes various functional applications and information processing by running software programs and modules.

The receiver 2202 and the transmitter 2203 may be implemented as a transceiver 2206, the transceiver 2206 may be a communication chip.

The memory 2204 is connected to the processor 2201 via the bus 2205.

The memory 2204 may be configured to store a computer program, and the processor 2201 is configured to execute the computer program to implement various steps performed by the terminal device in the above method embodiments.

In addition, the memory 2204 may be implemented by any type of volatile or non-volatile storage device or a combination thereof, and the volatile or non-volatile storage device includes but is not limited to: a Random-Access Memory (RAM) and a Read-Only Memory (ROM), an Erasable Programmable Read-Only Memory (EPROM), an Electrically Erasable Programmable Read-Only Memory (EEPROM), a flash memory or other solid-state storage technology, a Compact Disc Read-Only Memory (CD-ROM), a Digital Video Disc (DVD) or other optical storage, a tape cassette, a magnetic tape, a magnetic disk storage or other magnetic storage devices. Herein: the processor 2201 is configured to:
determine whether to start a second timer according to whether the terminal device is in a global navigation satellite system (GNSS) measurement period, in a case where a first timer times out, where the second timer is used to acquire system information within valid time of the second timer.

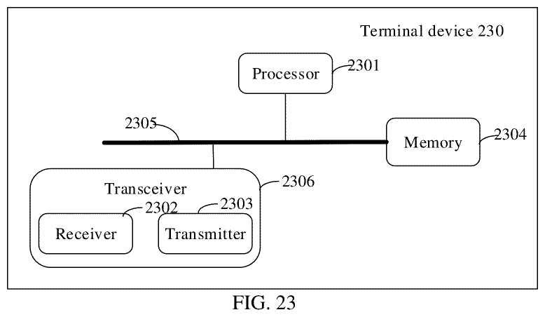

FIG. 23 is a structural schematic diagram of another terminal device according to the embodiments of the present disclosure. As shown in FIG. 23, the terminal device may be configured to perform the above-mentioned method for resolving a conflict between a measurement and a communication of a terminal device. For example, the terminal device 230 may include: a processor 2301, a receiver 2302, a transmitter 2303, a memory 2304 and a bus 2305.

The processor 2301 includes one or more processing cores. The processor 2301 executes various functional applications and information processing by running software programs and modules.

The receiver 2302 and the transmitter 2303 may be implemented as a transceiver 2306, the transceiver 2306 may be a communication chip.

The memory 2304 is connected to the processor 2301 via the bus 2305.

The memory 2304 may be configured to store a computer program, and the processor 2301 is configured to execute the computer program to implement various steps performed by the terminal device in the above method embodiments.

In addition, the memory 2304 may be implemented by any type of volatile or non-volatile storage device or a combination thereof, and the volatile or non-volatile storage device includes but is not limited to: a Random-Access Memory (RAM) and a Read-Only Memory (ROM), an Erasable Programmable Read-Only Memory (EPROM), an Electrically Erasable Programmable Read-Only Memory (EEPROM), a flash memory or other solid-state storage technology, a Compact Disc Read-Only Memory (CD-ROM), a Digital Video Disc (DVD) or other optical storage, a tape cassette, a magnetic tape, a magnetic disk storage or other magnetic storage devices. Herein: the processor 2301 is configured to:
determine starting time of a second timer and/or a duration of the second timer, when a first timer times out, in a case where the terminal device starts a GNSS measurement, where the second timer is used by the terminal device to acquire system information within valid time of the second timer.

It should be understood that the processor in the embodiments of the present disclosure may be an integrated circuit chip and have a processing capability of signals. In the implementation process, various steps of the above method embodiments may be completed by an integrated logic circuit of hardware in the processor or instructions in a software form. The above processor may be a general processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. The general processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in a decoding processor. The software module may be located in the mature storage medium in the art such as the random memory, the flash memory, the read-only memory, the programmable read-only memory or electrically erasable programmable memory, the register, etc. The non-transitory storage medium is located in the memory, and the processor reads the information in the memory and completes the steps of the above methods in combination with its hardware.

It may be understood that, the memory in the embodiments of the present disclosure may be a volatile memory or a non-volatile memory, or may include both the volatile memory and the non-volatile memory. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), ctc. That is, the memory in the embodiments of the present disclosure is intended to include, but not limited to, these and any other suitable types of memories.

The embodiments of the present disclosure further provide a non-transitory computer-readable storage medium for storing a computer program.

Optionally, the non-transitory computer-readable storage medium may be applied to the network device in the embodiments of the present disclosure, and the computer program causes a computer to perform the corresponding procedure implemented by the network device in the various methods of the embodiments of the present disclosure, which will not be repeated here for the sake of brevity.

Optionally, the non-transitory computer-readable storage medium may be applied to the mobile terminal/terminal device in the embodiments of the present disclosure, and the computer program causes a computer to perform the corresponding procedure implemented by the mobile terminal/terminal device in various methods of the embodiments of the present disclosure, which will not be repeated here for the sake of brevity.

The embodiments of the present disclosure further provide a computer program product including a computer program instruction.

Optionally, the computer program product may be applied to the network device in the embodiments of the present disclosure, and the computer program instruction causes a computer to perform the corresponding procedure implemented by the network device in the various methods of the embodiments of the present disclosure, which will not be repeated here for the sake of brevity.

Optionally, the computer program product may be applied to the mobile terminal/terminal device in the embodiments of the present disclosure, and the computer program instruction causes a computer to perform the corresponding procedure implemented by the mobile terminal/terminal device in various methods of the embodiments of the present disclosure, which will not be repeated here for the sake of brevity.

The embodiments of the present disclosure further provide a computer program.

Optionally, the computer program may be applied to the network device in the embodiments of the present disclosure, the computer program when being executed on a computer, causes the computer to perform the corresponding procedure implemented by the network device in various methods of the embodiments of the present disclosure, which will not be repeated here for the sake of brevity.

Optionally, the computer program may be applied to the mobile terminal/terminal device in the embodiments of the present disclosure, the computer program when being executed on a computer, causes the computer to perform the corresponding procedure implemented by the mobile terminal/terminal device in various methods of the embodiments of the present disclosure, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present disclosure.

It may be clearly understood by those skilled in the art that, for convenience and brevity of the description, the working procedures of the system, the apparatus and the unit described above may refer to the corresponding procedures in the above method embodiments, which will not be repeated here.

In the several embodiments provided by the disclosure, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

If the described functions are implemented in the form of a software functional unit and sold or used as an independent product, they may be stored in a non-transitory computer-readable storage medium. Based on this understanding, the technical solution of the present disclosure essentially, or a part of the technical solution that contributes to the prior art, or a part of the technical solution, may be embodied in the form of a software product, and the computer software product is stored in a non-transitory storage medium, and includes a plurality of instructions for enabling a computer device (which may be a personal computer, a server, or a network device, etc.) to perform all or some of steps of the methods described in the various embodiments of the present disclosure. And, the non-transitory storage medium mentioned above includes a USB flash drive (U disk), a mobile hard disk, a Read-Only Memory (ROM), a Random Access Memory (RAM), a diskette, or an optical disk, and various mediums that may store program codes.

The above content is only exemplary implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A method for resolving a conflict between a measurement and a communication of a terminal device, wherein the method comprises:
determining, by the terminal device, whether to start a second timer according to whether the terminal device is in a global navigation satellite system (GNSS) measurement period, in a case where a first timer times out, wherein the second timer is used by the terminal device to acquire system information within valid time of the second timer.

2. The method according to claim 1, wherein determining, by the terminal device, whether to start the second timer according to whether the terminal device is in the GNSS measurement period, comprises:
in a case where the first timer times out and the terminal device is not in the GNSS measurement period, starting, by the terminal device, the second timer.

3. The method according to claim 2, wherein after the terminal device starts the second timer, when the terminal determines to trigger a GNSS measurement, the method further comprises:
stopping, by the terminal device, the second timer, and starting the GNSS measurement.

4. The method according to claim 3, wherein after the terminal device starts the GNSS measurement, the terminal device performs the GNSS measurement within GNSS measurement time; wherein the GNSS measurement time comprises: a GNSS measurement interval.

5. The method according to claim 4, wherein performing, by the terminal device, the GNSS measurement within the GNSS measurement time, comprises:
when the GNSS position fix is not completed within the GNSS measurement time, entering, by the terminal device, an idle state; and
continuing, by the terminal device, the GNSS position fix.

6. The method according to claim 3, wherein after the terminal device stops the second timer and starts the GNSS measurement, the method further comprises:
when the terminal device completes GNSS position fix within the GNSS measurement time, restarting, by the terminal device, the second timer.

7. The method according to claim 1, wherein after the terminal device acquires the system information within the valid time of the second timer and a condition that a GNSS position of the terminal is valid is satisfied, the terminal device resumes uplink synchronization with a network device.

8. The method according to claim 1, wherein when the terminal device does not acquire the system information within the valid time of the second timer, the method further comprises:
triggering, by the terminal device, a radio link failure (RLF).

9. The method according to claim 1, further comprising:
receiving, by the terminal device, configuration information transmitted by a network device, wherein the configuration information comprises first timer information for running of the first timer and second timer information for running of the second timer.

10. The method according to claim 1, wherein the first timer comprises: a T317 timer; and the second timer comprises: a T318 timer; or
the system information at least comprises: a system information block (SIB) 31.

11. A method for resolving a conflict between a measurement and a communication of a terminal device, wherein the method comprises:
determining, by the terminal device, starting time of a second timer and/or a duration of the second timer, when a first timer times out, in a case where the terminal device starts a global navigation satellite system (GNSS) measurement, wherein the second timer is used by the terminal device to acquire system information within valid time of the second timer.

12. The method according to claim 11, wherein after the terminal device starts the GNSS measurement, the terminal device performs the GNSS measurement within GNSS measurement time; wherein the GNSS measurement time comprises:
a GNSS measurement interval.

13. The method according to claim 12, wherein performing, by the terminal device, the GNSS measurement within the GNSS measurement time, comprises:
when GNSS position fix is not completed within the GNSS measurement time, entering, by the terminal device, an idle state;
continuing, by the terminal device, the GNSS position fix.

14. The method according to claim 12, further comprising:
starting, by the terminal device, the second timer, when completing the GNSS position fix.

15. The method according to claim 14, wherein after the terminal device starts the second timer, when the terminal determines to trigger the GNSS measurement, the method further comprises:
stopping, by the terminal device, the second timer, and starting the GNSS measurement.

16. The method according to claim 14, wherein after the terminal device acquires the system information within the valid time of the second timer and a condition that a GNSS position of the terminal is valid is satisfied, the terminal device resumes uplink synchronization with a network device.

17. The method according to claim 14, wherein when the terminal device does not acquire the system information within the valid time of the second timer, the method further comprises:
triggering, by the terminal device, a radio link failure (RLF).

18. The method according to claim 14, further comprising:
receiving, by the terminal device, configuration information transmitted by a network device, wherein the configuration information comprises first timer information for running of the first timer and second timer information for running of the second timer.

19. The method according to claim 14, wherein the first timer comprises: a T317 timer; and the second timer comprises: a T318 timer; or
the system information at least comprises: a system information block (SIB) 31.

20. A terminal device, comprising: a processor and a memory, wherein the memory is configured to store a computer program, the processor is configured to call and run the computer program stored in the memory, to cause the terminal device to perform:
determining whether to start a second timer according to whether the terminal device is in a global navigation satellite system (GNSS) measurement period, in a case where a first timer times out, wherein the second timer is used by the terminal device to acquire system information within valid time of the second timer.
